(19) United States
(12) Patent Application Publication
(10) Pub. No.: US 2024/0413660 A1
(43) Pub. Date: Dec. 12, 2024

(54) SMART BATTERY CYCLE CHARGING METHOD AND DEVICE THEREOF

(71) Applicant: Quanta Computer Inc., Taoyuan City (TW)

(72) Inventor: Wei-Ting YEN, Taoyuan City (TW)

(21) Appl. No.: 18/463,505

(22) Filed: Sep. 8, 2023

(30) Foreign Application Priority Data
Jun. 12, 2023 (TW) 112121804

(51) Int. Cl. H02J 7/00; H01M 10/44; H01M 10/46; H01M 10/48

(52) U.S. Cl. CPC H02J 7/007182; H01M 10/441; H01M 10/46; H01M 10/482; H02J 7/0013; H02J 7/0047

(57) ABSTRACT

A smart battery cycle charging method includes detecting a current voltage per battery cell of battery cells in a battery device; according to voltage ranges and charging times corresponding to the voltage ranges in a mapping table, after detecting and determining that the current voltage per battery cell is within one of the voltage ranges, using a constant current to charge the battery cells for one of the charging times corresponding to the one of the voltage ranges; and using a constant voltage to charge the battery cells.

### CROSS REFERENCE TO RELATED APPLICATIONS

This application claims priority of Taiwan Patent Application No. 112121804, filed on Jun. 12, 2023, the entirety of which is incorporated by reference herein.

### BACKGROUND OF THE INVENTION

### Field of the Invention

The present invention relates to a smart battery cycle charging device, and, in particular, to a smart battery cycle charging device that detects the capacity of the battery device to determine the constant current charging time.

### Description of the Related Art

With the development of technology, many existing electronic devices are powered by battery devices. In many kinds of battery devices, lithium-ion batteries are widely used as a secondary battery in 3 C (computer, communication, and consumer electronics), EV (electric vehicle), ESS (energy storage systems), LEO (low earth orbit) satellite batteries and various IT products. Lithium-ion batteries are currently commonly used in the following systems: lithium cobalt oxide (LCO), nickel-cobalt-manganese (NCM) (ternary), and nickel-cobalt-aluminum (NCA).

However, due to the development of circular economy, increasing the charge and discharge times of the battery device to prolong the life of the battery device has become a challenge. Therefore, there is a need for a charging device that can minimize damage to the battery device during charging.

### BRIEF SUMMARY OF THE INVENTION

The present disclosure provides a smart battery cycle charging method. The smart battery cycle charging method includes detecting a current voltage per battery cell of battery cells in a battery device; according to voltage ranges and charging times corresponding to the voltage ranges in a mapping table, after detecting and determining that the current voltage per battery cell is within one of the voltage ranges, using a constant current to charge the battery cells for one of the charging times corresponding to the one of the voltage ranges; and using a constant voltage to charge the battery cells.

The present disclosure provides a smart battery cycle charging device. The smart battery cycle charging device includes a battery device and a charging device. The battery device has battery cells. The charging device has a processor and a mapping table, and is coupled to the battery cells. The mapping table has voltage ranges and charging times corresponding to the voltage ranges. After the processor detects and determines that a current voltage per battery cell is within one of the voltage ranges, the processor controls the charging device to use a constant current to charge the battery cells for one of the charging times corresponding to the one of the voltage ranges. After the one of the charging times, the processor controls the charging device to use a constant voltage to charge the battery cells.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only exemplary aspects of the disclosure and are not therefore to be considered to be limiting of its scope, the principles herein are described and explained with additional specificity and detail through the use of the accompanying drawings.

FIG. 1 illustrates a schematic diagram of a charging device, in accordance with some embodiments of the present disclosure.

FIG. 2 illustrates a schematic diagram of a battery device, in accordance with some embodiments of the present disclosure.

FIG. 3 illustrates a graph of a charging device charging a battery device, in accordance with some embodiments of the present disclosure.

FIG. 4 illustrates a schematic diagram of various series-parallel combinations of battery cells of a battery device, in accordance with some embodiments of the present disclosure.

FIGS. 5A and 5B illustrates a flow chart of a battery cycle charging method, in accordance with some embodiments of the present disclosure.

### DETAILED DESCRIPTION OF THE INVENTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at, near, or nearly at,” or “within 3-5% of,” or “within acceptable manufacturing tolerances,” or any logical combination thereof, for example.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. For example, if the device in the figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

The terminology used herein is for the purpose of describing particular embodiments only, and is not intended to be limiting of the invention. As used herein, the singular forms “a”, “an” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore terms, such as those defined in commonly used dictionaries, should be interpreted as having a meaning that is consistent with their meaning in the context of the relevant art, and will not be interpreted in an idealized or overly formal sense unless expressly so defined herein.

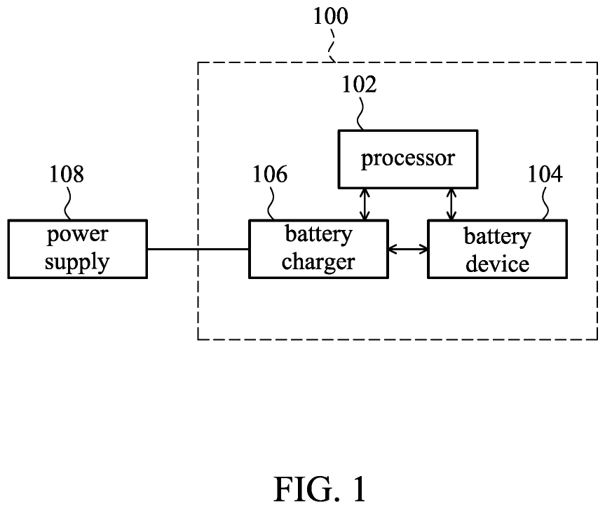

FIG. 1 illustrates a schematic diagram of a charging device 100, in accordance with some embodiments of the present disclosure. The charging device 100 includes a processor 102, a battery device 104, and a battery charger 106. The battery device 104 is coupled to the processor 102 to communicate with the charging device 100. In addition, the processor 102 is coupled to the battery charger 106 to control the charging device 100 to charge the battery device 104. The power supply 108 is connected to the battery charger 106 of the charging device 100. The power supply 108 may be a DC power supply, or a DC power supply converted from an AC power supply. The battery charger 106 is coupled to the battery device 104 to transmit the power provided by the power supply 108 to the battery device 104 to charge the battery device 104. The charging device 100 can also be other electronic device having a processor 102 and a battery charger 106 for charging the battery device 104. For example, the charging device 100 can be a notebook computer, a tablet computer, a smart phone, other 3 C electronic products, and the like. It should be understood that other configurations and inclusion or omission of various items in the charging device 100 may be possible. The charging device 100 is exemplary, and is not intended to limit the disclosure beyond what is explicitly recited in the claims.

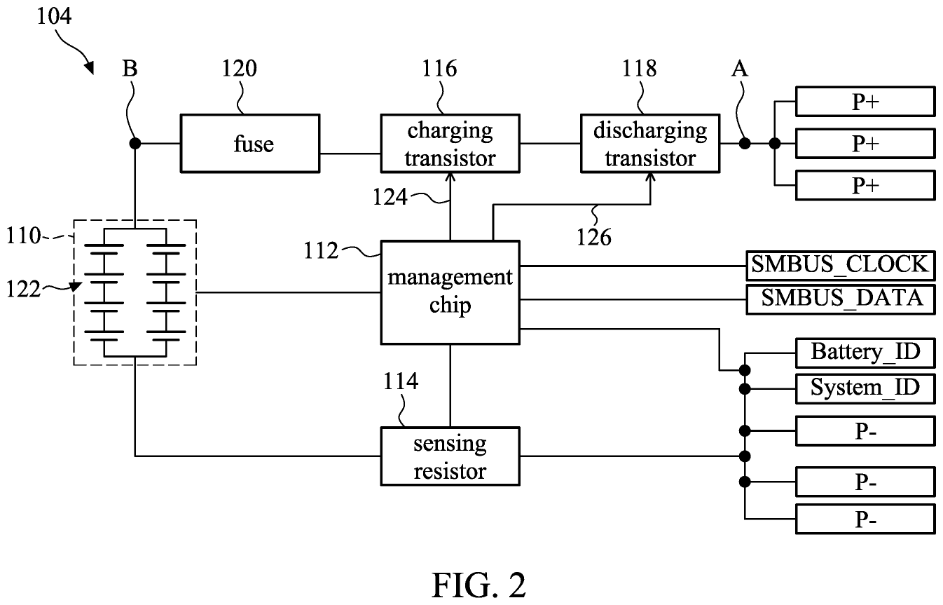

FIG. 2 further illustrates a schematic diagram of the battery device 104, in accordance with some embodiments of the present disclosure. As shown in FIG. 2, the battery device 104 discussed above may further include a battery pack 110, a management chip 112, a sensing resistor 114, a charging transistor 116, a discharging transistor 118, and a fuse 120. It should be understood that other configurations and inclusion or omission of various items in the battery device 104 may be possible. The battery device 104 is exemplary, and is not intended to limit the disclosure beyond what is explicitly recited in the claims.

The battery pack 110 may include battery cells 122. The battery cells 122 may be connected in a mixture of both the series and parallel. The battery cells 122 may store power. In the present embodiment, the battery cells 122 may be lithium-ion batteries. The lithium-ion battery is a rechargeable battery (secondary battery) that operates by moving lithium ions between positive and negative electrodes. The positive electrode of the lithium-ion battery is generally composed of a metal oxide containing lithium ions, and the negative electrode is generally a lattice composed of graphite. During charging, the lithium ions move toward the graphite's lattice. During discharge, the lithium ions move toward the metal oxide. The process of lithium ions entering the positive electrode (metal oxide) is called intercalation, and the process of leaving is called deintercalation; the process of lithium ions entering the negative electrode (graphite lattice) is called insertion, and the process of leaving is called extraction.

The management chip 112 is connected to the battery pack 110 to detect the voltage or capacity of the battery pack 110 (specifically, the battery cells 122). The charging transistor 116 and the discharging transistor 118 are coupled between the battery pack 110 and the positive electrodes P+ of the battery device 104. The management chip 112 is connected to the charging transistor 116 and the discharging transistor 118 to control the charging transistor 116 and the discharging transistor 118, thereby controlling the charging and discharging of the battery device 104. For example, the charging transistor 116 changes its state according to the control signal sent by the management chip 112 through the control line 124. For example, when the control signal of the control line 124 is “0”, the charging transistor 116 only allows the current to flow from the node B to the node A, but forbids the current to flow from the node A to the node B. When the control signal of the control line 124 is “1”, the charging transistor 116 is fully turned on. In some embodiments, the discharge transistor 118 changes its state according to the control signal sent by the management chip 112 through the control line 126. For example, when the control signal of the control line 126 is “0”, the discharge transistor 118 only allows the current to flow from the node A to the node B, but forbids the current to flow from the node B to the node A. When the control signal of the control line 126 is “1”, the discharge transistor 118 is fully turned on.

When the battery device 104 is connected to an external power source (e.g., the power supply 108 shown in FIG. 1), and the management chip 112 transmits a control signal “1” to the charge transistor 116 and transmits a control signal “0” to the discharge transistor 118, the battery pack 110 can be connected to the external power source, so that the received power can be stored in the battery cells 106 of the battery pack 110. When the management chip 112 transmits a control signal “0” to the charging transistor 116 and a control signal “0” to the discharging transistor 118, the battery of the battery pack 110 can be disconnected from the external power source, so that the battery device 104 stops being charged.

When the management chip 112 transmits a control signal “0” to the charge transistor 116 and transmits a control signal “1” to the discharge transistor 118, the battery pack 110 can be connected to the processor 102 of the charging device 100, so that the battery device 104 can provide power to the charging device 100. When the management chip 112 transmits a control signal “0” to the charge transistor 116 and a control signal “0” to the discharge transistor 118, the battery pack 110 can be disconnected from the charging device 100, so that the battery device 104 stops providing power.

The management chip 112 is an integrated circuit device, which may include processor, microprocessor, controller, memory, other suitable integrated circuits, or combinations thereof. The management chip 112 may detect the voltage, capacity, etc. of the battery pack 110 (or the battery device 104), and control the battery device 104 according to the detected data.

The sensing resistor 114 is coupled to the battery pack 110, the management chip 112, and the negative electrodes P− of the battery device 104. The sensing resistor 114 may detect the discharge current of the battery device 104. In some embodiments, when the battery device 104 is connected to the processor 102 of the electronic device 100, the management chip 112 may check whether the discharge current of the battery device 104 detected by the sensing resistor 114 exceeds the protection value. When the discharge current of the battery device 104 exceeds the protection value, the management chip 112 may control the charging transistor 116 and the discharging transistor 118 to stop the battery device 104 from providing power, so as to avoid damage or danger to the battery device 104.

The fuse 120 is coupled between the battery pack 110 and the charging transistor 116. The fuse 120 serve as the secondary protection of the battery device 104. For example, when the management chip 112 detects that the charging transistor 116 and the discharging transistor 118 fail and cannot be turned off so that the battery device 104 stops providing power, the management chip 112 instructs to disconnect the fuse 120 so that the battery device 104 stops providing power.

In the present embodiment, the battery device 104 further includes a plurality of pins. As shown in FIG. 2, the battery device 104 further includes a clock pin SMBUS_CLOCK, a data pin SMBUS_DATA, an identification pin Battery_ID, and an identification pin System_ID. The battery device 104 can communicate with the processor 102 of the charging device 100 through the clock pin SMBUS_CLOCK and the data pin SMBUS_DATA. The identification pin Battery_ID makes the charging device 100 powered by the battery device 104 to identify the battery device 104. The identification pin System_ID makes the battery device 104 to identify the charging device 100 powered by the battery device 104.

The present disclosure can use the charging device 100 and the battery device 104 as a battery cycle charging device to perform a battery cycle charging method to increase the number of charge and discharge times of the battery device 104 to prolong the life of the battery device 104. Specifically, the charging device 100 can firstly charge the battery device 104 with a constant current in a constant current mode. After charging the battery device 104 to 70% of a maximum capacity of the battery device 104, the charging device 100 switches to a constant voltage mode to charge the battery device 104 with a constant voltage. In some embodiments, this charging method may be referred to as a constant current-constant voltage (CC-CV) charging method. As such, the charging method can not only charge with a constant current to reduce the charging time, but also charge with a constant voltage to prevent the battery device 104 from being overcharged. In some embodiments, when the battery device 104 is fully charged, the charging device 100 will switch to the float charging mode to keep the battery device 104 in a fully charged state with a lower constant voltage.

The table below analyzes various commonly used lithium-ion battery cells to determine the charging voltage of the charging device 100 in the constant voltage mode.

| | | | | | | | | |
|---|---|---|---|---|---|---|---|---|
| positive | LCO | LCO | LCO | LCO | LCO | NCM | NCM | NCM |
| electrode | ED710 | ED750 | ED810 | ED830 | ED860 | 613 | 613 | 811 |
| negative | Graphite | Graphite | Graphite | Graphite | Graphite | Graphite | Graphite | Graphite |
| electrode | | | | | | | | |
| Charging | 4.40 | 4.45 | 4.48 | 4.50 | 4.53 | 4.40 | 4.45 | 4.30 |
| voltage (V) | | | | | | | | |
| Nominal | 3.85 | 3.87 | 3.88 | 3.90 | 3.91 | 3.75 | 3.77 | 3.72 |
| voltage (V) | | | | | | | | |

The above table illustrates 8 commonly used lithium-ion battery cells, in which there are 5 lithium cobalt oxide (LCO) battery cells and 3 nickel-cobalt-manganese (NCM) lithium battery cells according to the material of the positive electrode (may be referred to as a ternary battery cell). As shown in the above table, it can be known that the charging voltage of the commonly used lithium-ion battery cells is at least 4.3V. Therefore, in the present embodiment, the charging device 100 is set to use a charging voltage of 4.2V per battery cell in the constant voltage mode, which is suitable for common lithium-ion battery cells. In addition, charging with a lower charging voltage can avoid overcharging of the battery device or minimize damage to the battery device during charging, so as to prolong the life of the battery device.

Next, determine the constant charging current and charging time used by the charging device 100 in the constant current mode. In the present embodiment, in order to avoid overcharging of the battery device 104 (specifically, the battery cells 122) or minimize charging damage to the battery device 104 during charging, the charging device 100 charges the battery device 104 using a C-rate of 0.8 C in the constant current mode. 1 C means that the capacity of the battery device is fully charged/discharged within 1 hour, and 2 C means that the capacity of the battery device is fully charged/discharged within 0.5 hours. For example, a battery device with a maximum capacity of 3000 mAh means that if the battery device is charged from battery dead using 3 A, it can be charged for 1 hour. If the charging current is 3 A, it means charging using 1 C, and if the charging current is 6 A, it means charging using 2 C.

In the present embodiment, the battery voltage of each of the battery cells 122 is 4.2V when fully charged and is 3V when battery dead. In order to avoid overcharging of the battery device 104 (specifically, the battery cells 122) or to minimize damage to the battery device 104 during charging, the charging device 100 charges the battery device 104 to 70% of the maximum capacity of the battery device 104 with a constant current in the constant current mode, as discussed above.

The table below illustrates the time required for each of battery cells 122 of the battery device 104 of the present embodiment to be charged to 70% of the maximum capacity under different voltage ranges.

| | Voltage range (V) | | | | | |
|---|---|---|---|---|---|---|
| | ≤3.0 | 3.0~3.2 | 3.2~3.5 | 3.5~3.7 | 3.7~4.0 | <4.0 |
| charging | 60 | 50 | 40 | 30 | 20 | 10 |
| time (min) | | | | | | |

In the present embodiment, the charging device 100 includes a mapping table of voltage ranges and charging times corresponding to the voltage ranges as shown in the above table. When the processor 102 of the charging device 100 detects and determines that the current voltage per battery cell of the battery cells 122 in the battery device 104 is in one of the voltage ranges shown in the above table, the processor 102 then controls the charging device 100 to charge the battery cells 122 in the battery device 104 with a constant current (0.8 C, as discussed above) and for a corresponding charging time. For example, when the processor 102 of the charging device 100 detects that the current voltage per battery unit of the battery cells 122 is 3.6V, the processor 102 can know that 3.6V is in the range of 3.5V to 3.7V according to the mapping table (shown in the above table), and thus use a constant current to charge the battery cells 122 in the battery device 104 for the corresponding charging time (i.e., about 30 minutes).

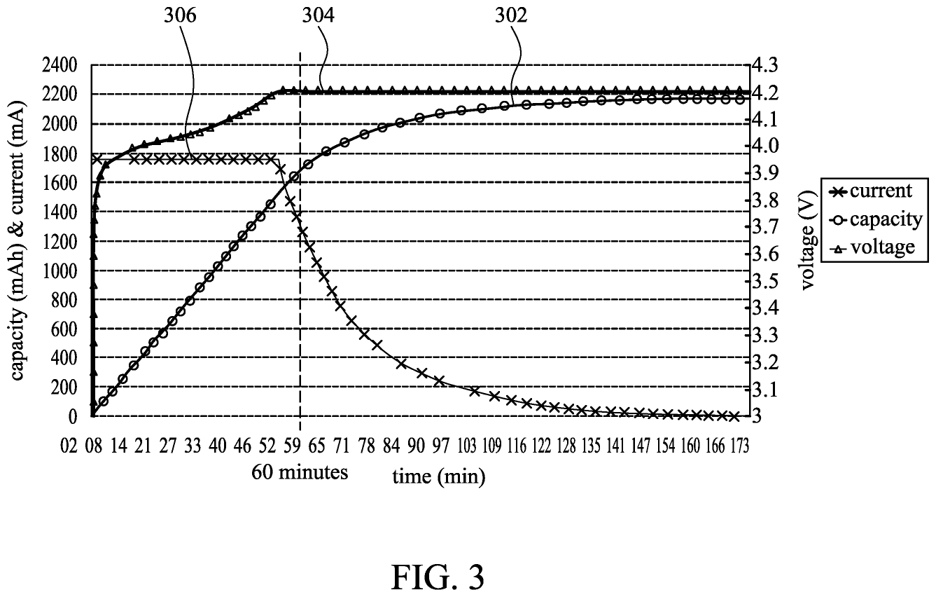

FIG. 3 illustrates a graph of charging the battery device 104 with a maximum capacity of 2200 mAh from a voltage of 3V and a capacity of 0 mAh. As shown in FIG. 3, the curve 302 represents the capacity of the battery device 104, the curve 304 represents the voltage per battery cell of the battery cells 122 of the battery device 104, and the curve 306 represents the charging current. As shown in the curve 304, since the battery device 104 is charged from 3V per battery cell, it can be known that 3V is in the range of less than or equal to 3.0V according to the above table. It can be known that the charging device 100 first charges the battery device 104 with a constant current for about 60 minutes to charge the battery device 104 to 70% of the maximum capacity of the battery device 104. In addition, as discussed above, the charging device 100 charges the battery device 104 using a C-rate of 0.8 C in the constant current mode. Therefore, in FIG. 3, the curve 304 (charging current) illustrates that the charging device 100 charges the battery device 104 with a constant current of 1750 mA (2200×0.8) for about 60 minutes. The curve 302 illustrates that when the battery device 104 is charged for about 60 minutes, the capacity of the battery unit 104 increases from 0 mAh to 1550 mAh, which is approximately equal to 70% of the maximum capacity of the battery device 104 (1550/2200×100%). Furthermore, the curve 304 illustrates that the voltage per battery cell of the battery device 104 goes from 3V to about 4.2V when the battery device 104 is charged for about 60 minutes.

As shown in FIG. 3, after the charging device 100 charges the battery device 104 in the constant current mode, the charging device 100 charges the battery device 104 in the constant voltage mode. In the present embodiment, the charging device 100 uses a charging voltage of 4.2V per battery cell in the constant voltage mode. Therefore, the curve 304 illustrates that the voltage per battery cell of the battery device 104 stabilizes using about 4.2V. The curve 302 illustrates that the battery device 104 reaches about 2200 mAh when the battery device 104 is charged for about 180 minutes. In addition, the curve 306 illustrates that the charging current continues to decrease, thereby reducing the damage to the battery device 104 during charging.

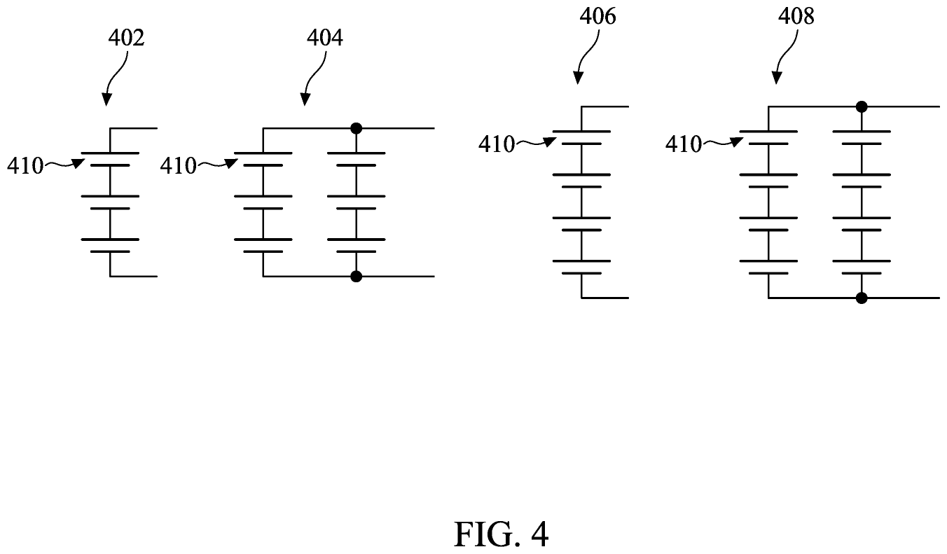

FIG. 4 illustrates a schematic diagram of various series-parallel combinations of battery cells of a battery device, in accordance with some embodiments of the present disclosure. As discussed above, the charging device 100 charges the battery device 104 using a C-rate of 0.8 C in the constant current mode, and after charging the battery device 104 to 70% of the maximum capacity of the battery device 104, the charging device 100 charges the battery device 104 using a charging voltage of 4.2V per battery cell in the constant voltage mode. Therefore, the constant current and the constant voltage used by the charging device 100 are different according to various series-parallel combinations of the battery cells 122 in the battery pack 110 of the battery device 104. FIG. 4 illustrates four battery packs 402 to 408 with different series-parallel combinations of the battery cells. The battery pack 402 has three battery cells 410 in series (3 Series; 3S); the battery pack 404 has two parallel sets of three battery cells 410 in series (3 Series/2 Parallel; 3S2P); the battery pack 406 has four battery cells 410 in series (4S); and the battery pack 408 has two parallel sets of four battery cells 410 in series (4 Series/2 Parallel; 4S2P).

When the battery cells are in series, the voltage will increase but the capacity will not change. When the battery cells are in parallel, the capacity will increase and the voltage will not change. Assume that single battery cell 410 has a capacity of 2000 mAh, the battery pack 402 has a capacity of 2000 mAh; the battery pack 404 has a capacity of 4000 mAh; the battery pack 406 has a capacity of 2000 mAh; and the battery pack 408 has a capacity of 4000 mAh. Therefore, assume that the charging device 100 charges the battery packs 402 to 408 using a C-rate of 0.8 C in the constant current mode, the charging device 100 charges the battery pack 402 using 1.6 A (2000×0.8/1000), charges the battery pack 404 using 3.2 A (4000×0.8/1000), charges the battery pack 406 using 1.6 A (2000×0.8/1000), and charges the battery pack 408 using 1.6 A (4000×0.8/1000). Assume that the charging device 100 charges the battery packs 402 to 408 using a charging voltage of 4.2V per battery cell in the constant voltage mode, the charging device 100 charges the battery pack 402 using 12.6V (4.2×3), charges the battery pack 404 using 12.6V (4.2×3), charges the battery pack 406 using 16.8V (4.2×4), and charges the battery pack 408 using 16.8V (4.2×4).

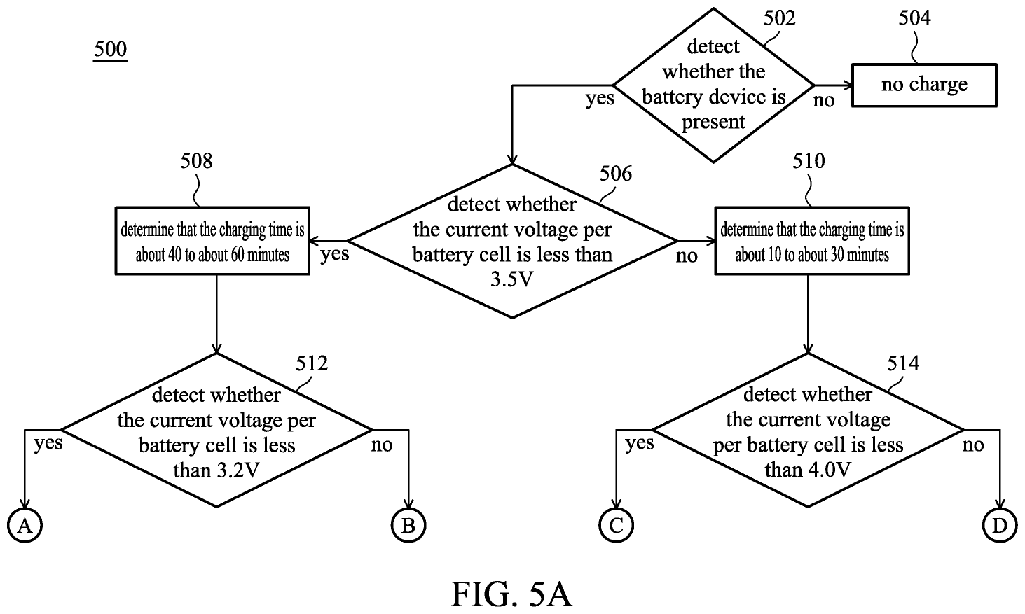

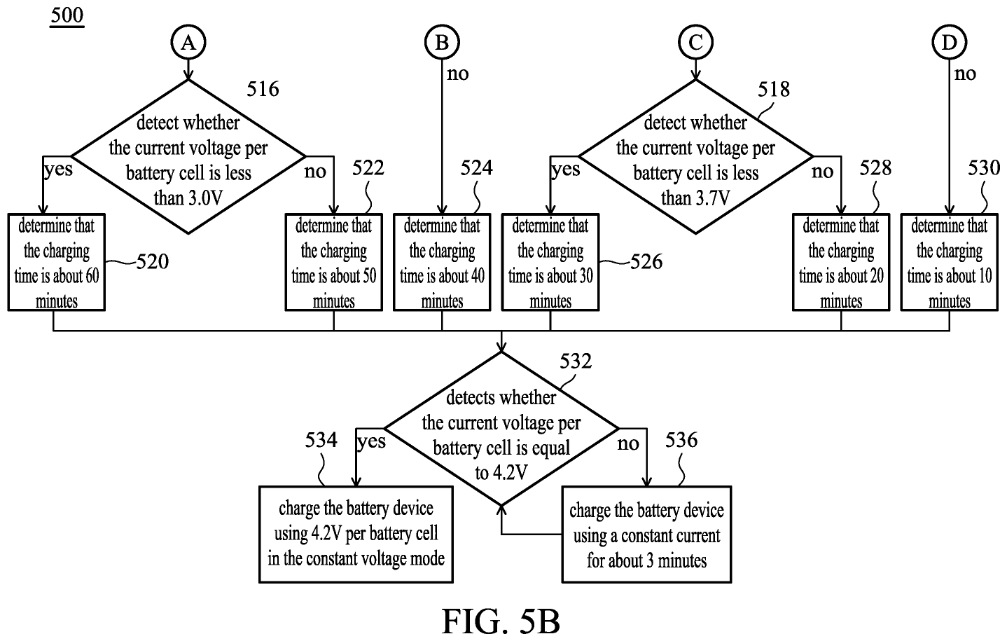

FIGS. 5A and 5B illustrates a flowchart of a battery cycle charging method 500, in accordance with some embodiments of the present disclosure. In operation 502, the processor 102 of the charging device 100 detects whether the battery device 104 is present. Specifically, the processor 102 of the charging device 100 detects whether the battery device 104 has been set in the charging device 100 to be charged. If yes, the battery cycling charging method 500 proceeds to operation 506; if not, the battery cycling charging method 500 proceeds to operation 504.

In operation 504, since the processor 102 of the charging device 100 detects that the battery device 104 does not exist, the charging device 100 does not perform the charging operation. In operation 506, the processor 102 of the charging device 100 detects whether the current voltage per battery cell of the battery cells 122 of the battery device 104 is less than 3.5V. If yes, the battery cycling charging method 500 proceeds to operation 508; if not, the battery cycling charging method 500 proceeds to operation 510.

In operation 508, according to the mapping table in the charging device 100, the charging device 100 determines that the battery device 104 will be charged in the constant current mode of the charging device 100 for about 40 to about 60 minutes. Specifically, the processor 102 of the charging device 100 detects that the current voltage per battery cell of the battery cells 122 of the battery device 104 is less than 3.5V in operation 506. Next, in operation 508, according to the mapping table in the charging device 100 (as shown in the above table), the processor 102 of the charging device 100 determines that the charging time for the voltage per battery cell less than 3.5V is about 40 to about 60 minutes. Therefore, it is determined that the charging device 100 charges the battery cells 122 of the battery device 104 using a constant current (a C-rate of 0.8 C, as discussed above) for about 40 to about 60 minutes in the constant current mode.

In operation 510, according to the mapping table in the charging device 100, the charging device 100 determines that the battery device 104 will be charged in the constant current mode of the charging device 100 for about 10 to about 30 minutes. Specifically, the processor 102 of the charging device 100 detects that the current voltage per battery cell of the battery cells 122 of the battery device 104 is greater than 3.5V in operation 506. Next, in operation 510, according to the mapping table in the charging device 100 (as shown in the above table), the processor 102 of the charging device 100 determines that the charging time for the voltage per battery cell greater than 3.5V is about 40 to about 60 minutes. Therefore, it is determined that the charging device 100 charges the battery cells 122 of the battery device 104 using a constant current (a C-rate of 0.8 C, as discussed above) for about 40 to about 60 minutes in the constant current mode.

In operation 512, the processor 102 of the charging device 100 detects whether the current voltage per battery cell of the battery cells 122 of the battery device 104 is less than 3.2V. If yes, the battery cycling charging method 500 proceeds to operation 516; if not, the battery cycling charging method 500 proceeds to operation 524.

In operation 514, the processor 102 of the charging device 100 detects whether the current voltage per battery cell of the battery cells 122 of the battery device 104 is less than 4.0V. If yes, the battery cycling charging method 500 proceeds to operation 518; if not, the battery cycling charging method 500 proceeds to operation 530.

In operation 516, the processor 102 of the charging device 100 detects whether the current voltage per battery cell of the battery cells 122 of the battery device 104 is less than 3.0V. If yes, the battery cycling charging method 500 proceeds to operation 520; if not, the battery cycling charging method 500 proceeds to operation 522.

In operation 518, the processor 102 of the charging device 100 detects whether the current voltage per battery cell of the battery cells 122 of the battery device 104 is less than 3.7V. If yes, the battery cycling charging method 500 proceeds to operation 526; if not, the battery cycling charging method 500 proceeds to operation 528.

In operation 520, according to the mapping table in the charging device 100, the charging device 100 determines that the battery device 104 will be charged for about 60 minutes in the constant current mode of the charging device 100. Specifically, the processor 102 of the charging device 100 detects that the current voltage per battery cell of the battery cells 122 of the battery device 104 is less than or equal to 3.0V in operation 516. Therefore, the processor 102 of the charging device 100 determines that the current voltage per battery cell is in the range of less than 3.2V. According to the mapping table in the charging device 100 (as shown in the above table), the processor 102 of the charging device 100 determines that the current voltage per battery cell less than or equal to 3.0V corresponds charging time of about 60 minutes. Therefore, it is determined that the charging device 100 uses a constant current (a C-rate of 0.8 C, as discussed above) to charge the battery cells 122 of the battery device 104 for about 60 minutes in the constant current mode.

In operation 522, according to the mapping table in the charging device 100, the charging device 100 determines that the battery device 104 will be charged for about 50 minutes in the constant current mode of the charging device 100. Specifically, the processor 102 of the charging device 100 detects that the current voltage per battery cell of the battery cells 122 of the battery device 104 is greater than or equal to 3.0V in operation 516 and the current voltage per battery cell of the battery cells 122 of the battery device 104 is less than 3.2V in operation 512. Therefore, the processor 102 of the charging device 100 determines that the current voltage per battery cell is in the range of 3.0V to 3.2V. According to the mapping table in the charging device 100 (as shown in the above table), the processor 102 of the charging device 100 determines that the current voltage per battery cell in the range of 3.0V to 3.2V corresponds charging time of about 50 minutes. Therefore, it is determined that the charging device 100 uses a constant current (a C-rate of 0.8 C, as discussed above) to charge the battery cells 122 of the battery device 104 for about 50 minutes in the constant current mode.

In operation 524, according to the mapping table in the charging device 100, the charging device 100 determines that the battery device 104 will be charged for about 40 minutes in the constant current mode of the charging device 100. Specifically, the processor 102 of the charging device 100 detects that the current voltage per battery cell of the battery cells 122 of the battery device 104 is greater than 3.2V in operation 512 and the current voltage per battery cell of the battery cells 122 of the battery device 104 is less than 3.5V in operation 506. Therefore, the processor 102 of the charging device 100 determines that the current voltage per battery cell is in the range of 3.2V to 3.5V. According to the mapping table in the charging device 100 (as shown in the above table), the processor 102 of the charging device 100 determines that the current voltage per battery cell in the range of 3.2V to 3.5V corresponds charging time of about 40 minutes. Therefore, it is determined that the charging device 100 uses a constant current (a C-rate of 0.8 C, as discussed above) to charge the battery cells 122 of the battery device 104 for about 40 minutes in the constant current mode.

In operation 526, according to the mapping table in the charging device 100, the charging device 100 determines that the battery device 104 will be charged for about 30 minutes in the constant current mode of the charging device 100. Specifically, the processor 102 of the charging device 100 detects that the current voltage per battery cell of the battery cells 122 of the battery device 104 is less than 3.7V in operation 518 and the current voltage per battery cell of the battery cells 122 of the battery device 104 is greater than 3.5V in operation 506. Therefore, the processor 102 of the charging device 100 determines that the current voltage per battery cell is in the range of 3.5V to 3.7V. According to the mapping table in the charging device 100 (as shown in the above table), the processor 102 of the charging device 100 determines that the current voltage per battery cell in the range of 3.5 to 3.7V corresponds charging time of about 30 minutes. Therefore, it is determined that the charging device 100 uses a constant current (a C-rate of 0.8 C, as discussed above) to charge the battery cells 122 of the battery device 104 for about 30 minutes in the constant current mode.

In operation 528, according to the mapping table in the charging device 100, the charging device 100 determines that the battery device 104 will be charged for about 20 minutes in the constant current mode of the charging device 100. Specifically, the processor 102 of the charging device 100 detects that the current voltage per battery cell of the battery cells 122 of the battery device 104 is greater than 3.7V in operation 518 and the current voltage per battery cell of the battery cells 122 of the battery device 104 is less than 4.0V in operation 514. Therefore, the processor 102 of the charging device 100 determines that the current voltage per battery cell is in the range of 3.7V to 4.0V. According to the mapping table in the charging device 100 (as shown in the above table), the processor 102 of the charging device 100 determines that the current voltage per battery cell in the range of 3.7 to 4.0V corresponds charging time of about 20 minutes. Therefore, it is determined that the charging device 100 uses a constant current (a C-rate of 0.8 C, as discussed above) to charge the battery cells 122 of the battery device 104 for about 20 minutes in the constant current mode.

In operation 530, according to the mapping table in the charging device 100, the charging device 100 determines that the battery device 104 will be charged for about 10 minutes in the constant current mode of the charging device 100. Specifically, the processor 102 of the charging device 100 detects that the current voltage per battery cell of the battery cells 122 of the battery device 104 is greater than 4.0V in operation 514. Therefore, the processor 102 of the charging device 100 determines that the current voltage per battery cell is in the range of greater than 4.0V. According to the mapping table in the charging device 100 (as shown in the above table), the processor 102 of the charging device 100 determines that the current voltage per battery cell in the range of greater than 4.0V corresponds charging time of about 10 minutes. Therefore, it is determined that the charging device 100 uses a constant current (a C-rate of 0.8 C, as discussed above) to charge the battery cells 122 of the battery device 104 for about 10 minutes in the constant current mode.

After the charging device 100 charges the battery cells 122 of the battery device 104 using a constant current in the constant current mode in operations 520 to 530, the battery cycle charging method 500 proceeds to operation 532. In operation 532, the processor 102 of the charging device 100 detects whether the current voltage per battery cell of the battery cells 122 of the battery device 104 is equal to 4.2V. If yes, the battery cycling charging method 500 proceeds to operation 534; if not, the battery cycling charging method 500 proceeds to operation 536.

In operation 534, the charging device 100 charges the battery cells 122 of the battery device 104 using a constant voltage in a constant voltage mode. Specifically, in the present embodiment, the charging device 100 charges the battery cells 122 of the battery device 104 using a charging voltage of 4.2V per battery cell in the constant voltage mode until the battery device 104 is fully charged, as discussed above. In some embodiments, when the battery device 104 is fully charged, the charging device 100 will switch to the float charging mode to keep the battery device 104 in a fully charged state with a lower constant voltage.

In operation 536, since the processor 102 of the charging device 100 detects that the current voltage per battery cell of the battery cells 122 of the battery device 104 is not equal to 4.2V in operation 532, the charging device 100 charges the battery cells 122 of the battery device 104 using a constant current (a C-rate of 0.8 C, as discussed above) for about 3 minutes in the constant current mode until the processor 102 of the charging device 100 detects that the current voltage per cell of the battery unit 122 of the battery device 104 is equal to 4.2V. In other words, after the charging device 100 charges the battery cells 122 of the battery device 104 using a constant current (a C-rate of 0.8 C, as discussed above) for about 3 minutes in the constant current mode, the battery cycle charging method 500 again proceeds to operation 532, such that the processor 102 of the charging device 100 detects again whether the current voltage per battery cell of the battery cells 122 of the battery device 104 is equal to 4.2V.

The embodiments of the present disclosure offer advantages over existing art, though it should be understood that other embodiments may offer different advantages, not all advantages are necessarily discussed herein, and that no particular advantage is required for all embodiments. By using the embodiments of the present disclosure, the devices and methods of the present disclosure may quickly charge the battery device, and minimize the damage to the battery device during charging, so as to prolong the life of the battery device.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A smart battery cycle charging method, comprising:
detecting a current voltage per battery cell of battery cells in a battery device;
according to voltage ranges and charging times corresponding to the voltage ranges in a mapping table, after detecting and determining that the current voltage per battery cell is within one of the voltage ranges, using a constant current to charge the battery cells for one of the charging times corresponding to the one of the voltage ranges; and
using a constant voltage to charge the battery cells.

2. The smart battery cycle charging method as claimed in claim 1, wherein after charging the battery cells using the fixed current for the one of the charging times, the battery device is charged to about 70% of a maximum capacity of the battery device.

3. The smart battery cycle charging method as claimed in claim 1, wherein using the constant current to charge the battery cells uses a C-rate of 0.8 C to charge the battery cells.

4. The smart battery cycle charging method as claimed in claim 1, wherein the constant voltage is 4.2V per battery cell.

5. The smart battery cycle charging method as claimed in claim 1, wherein the voltage ranges comprise:
a first range, wherein the current voltage per battery cell is less than or equal to 3V;
a second range, wherein the current voltage per battery cell is between 3V and 3.2V;
a third range, wherein the current voltage per battery cell is between 3.2V and 3.5V;
a fourth range, wherein the current voltage per battery cell is between 3.5V and 3.7V;
a fifth range, wherein the current voltage per battery cell is between 3.7V and 4V; and
a sixth range, wherein the current voltage per battery cell is greater than 4V.

6. The smart battery cycle charging method as claimed in claim 5, wherein the charging times corresponding to the voltage ranges comprise:
a first time corresponding to the first range and being 60 minutes;
a second time corresponding to the second range and being 50 minutes;
a third time corresponding to the third range and being 40 minutes;
a fourth time corresponding to the fourth range and being 30 minutes;
a fifth time corresponding to the fifth range and being 20 minutes; and
a sixth time corresponding to the sixth range and being 10 minutes.

7. A smart battery cycle charging device, comprising:
a battery device having battery cells; and
a charging device having a processor and a mapping table, and coupled to the battery cells,
wherein the mapping table has voltage ranges and charging times corresponding to the voltage ranges,
wherein after the processor detects and determines that a current voltage per battery cell is within one of the voltage ranges, the processor controls the charging device to use a constant current to charge the battery cells for one of the charging times corresponding to the one of the voltage ranges, and
wherein after the one of the charging times, the processor controls the charging device to use a constant voltage to charge the battery cells.

8. The smart battery cycle charging device as claimed in claim 7, wherein after the processor controls the charging device to use the constant current to charge the battery cells for the one of the charging times, the battery device is charged to about 70% of a maximum capacity of the battery device.

9. The smart battery cycle charging device as claimed in claim 7, wherein the charging device charges the battery cells using a C-rate of 0.8.

10. The smart battery cycle charging device as claimed in claim 7, wherein the constant voltage is 4.2V per battery cell.
